(19) United States
(12) Patent Application Publication
(10) Pub. No.: US 2012/0293410 A1
(43) Pub. Date: Nov. 22, 2012

(54) Flexible Input Device Worn on a Finger

(76) Inventor: Ian Bell, London (GB)

(21) Appl. No.: 13/110,621

(22) Filed: May 18, 2011

(51) Int. Cl. G06F 3/033

(52) U.S. Cl. 345/158

(57) ABSTRACT

Methods and apparatus are directed to an input device including a wearable ring shaped component that is supported on a finger and located between a finger tip and a knuckle of the wearer. The wearable component comprises a touch pad device that is located on an outward surface of the wearable ring shaped component. The touch pad device is contacted to provide an input command. The wearable component includes a transmitter to transmit the input command.

### FIELD OF THE INVENTION

The present invention relates generally to an input device, and more particularly to an input device that can be worn on a hand and that tracks an impedance of a user's finger.

### BACKGROUND

The term “computer mouse” or “mouse” generally refers to a device used to input location information to a cursor on a computer display device and to perform functions related to objects displayed on the display device.

The location information is conveyed to the display device by moving the mouse across a surface. This movement is relayed to the computer where it is translated into a corresponding movement of the cursor on the display.

A mouse may use mechanical sensors to acquire the location information. In this type of mouse, a ball rotates against sensors to develop signals that correspond to the movement of the ball, which is then sent to the computer to move the cursor on the computer display screen in the “X-Y” plane. The mechanical ball may be located on the bottom of the mouse such that when the mouse is moved, the ball rotates.

A “trackball” mouse has the mechanical ball on the top or side of the mouse housing and the user moves the ball and not the mouse housing. The trackball mouse is touted as reducing fatigue and saving space.

An “opto-mechanical” mouse basically functions in the same way as a mechanical mouse, but uses optical sensors to detect mouse ball movement. A pure optical mouse uses a laser to detect mouse motion.

A mouse may connect to the display device through a wire or wirelessly. Wireless communication may be by radio signal or infrared signals.

A mouse may also utilize “buttons” to send commands to a computer. The commands may be context sensitive in that the command that is sent may depend on the objects being displayed on the display device.

Laptops and other computers provide a sensor pad that associates the movement of a finger across the pad with the movement of a cursor.

Another class of input devices is wearable devices. A glove may be fitted with sensors that can be used to receive location data and command data. The sensors used in these devices include ball-based sensors, pressure sensors and optical sensors. For example, in U.S. Pat. No. 6,154,199 issued to Butler a glove having a tracking ball is supported in a housing and is attached to the side of the index finger so that the tracking ball can be operated by the thumb. Mouse buttons are positioned on the palm of the glove for activating mouse “click” functions.

### SUMMARY OF THE INVENTION

According to an embodiment, an input device includes a component that is supported on a finger and is located between a finger tip and a knuckle at a base of the finger of the wearer. The wearable component comprises a touch pad device that is located on an outward surface of the component. The touch pad device is contacted to provide an input command. The component includes a transmitter to transmit the input command.

According to another embodiment a method includes providing a first member on a body part. The first member has an inner surface touching the body part and an opposite outer surface. A touch pad is on the outer surface. The method includes inputting data using a thumb to touch the touch pad and wirelessly transmitting the data to a destination.

According to yet another embodiment, a computer includes a processor, a memory, a receiver, and a display. The computer has an input device supported on a finger that comprises a touch pad device that is located on an outward surface. The touch pad device is contacted to provide an input command and has a transmitter to transmit the input command to the receiver and to provide inputs to the processor.

According to yet another embodiment, a component may include a cylindrical member that is opened at both ends to reveal a finger tip to give the user acceptable tactile feedback when using a keyboard and when using a touch screen device.

### BRIEF DESCRIPTION OF THE FIGURES

The accompanying drawings, which are incorporated herein and constitute part of this specification, illustrate exemplary embodiments of the invention, and together with the general description given above and the detailed description given below, serve to explain various features of the embodiments illustrated herein, and are not meant to be limiting.

FIG. 1 illustrates an input device that has a touch pad that may be engaged using a thumb that is suitable for use with various embodiments.

FIG. 2 is a first side view of an embodiment of the input device of FIG. 1.

FIG. 3 is an opposite side view of an embodiment of the input device of FIG. 2.

FIG. 4 illustrates a high level schematic view of the input device communicating with a dongle that is connected to a port of a laptop computer device.

FIG. 5 illustrates functional modules involved in generating input signals from an input device to a computing device using a thumb to render the inputs.

FIG. 6 illustrates an embodiment method to generate input signals from an index finger touch pad device.

FIG. 7 illustrates a bone structure of a hand for illustrating placement of the index finger touch pad input device.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the terms “computer device” and “handheld mobile device” refer to any one or all of cellular telephones, personal data assistants (PDA's), palm-top computers, wireless electronic mail receivers, multimedia Internet enabled cellular telephones, Global Positioning System (GPS) receivers, wireless gaming controllers, tablet computers, notebook computers, net book computers, wireless email devices, and similar personal electronic devices that include a programmable processor and memory. As used herein, the terms “component,” “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

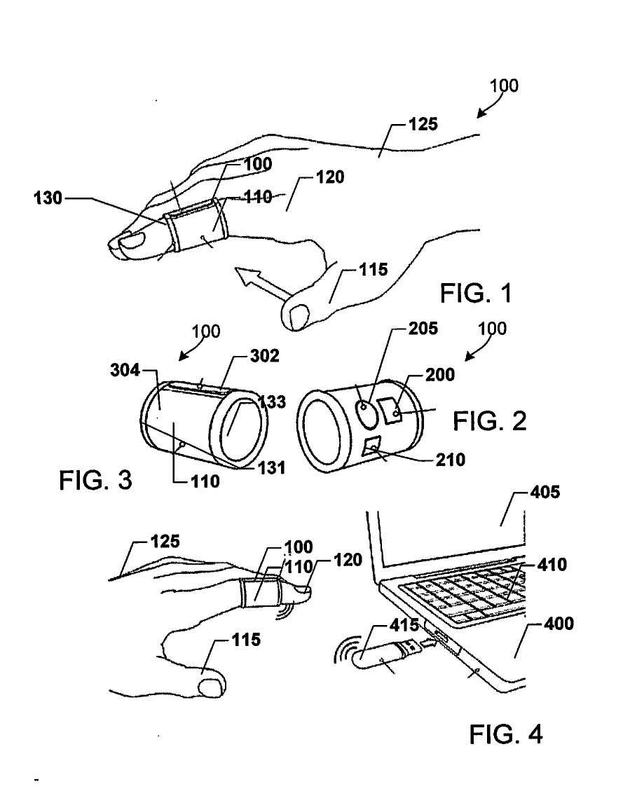

FIG. 1 illustrates an embodiment of an input device 100 according to the present disclosure. The input device 100 uses impedance tracking for reading movement. The input device 100 includes improved operating characteristics in that carpal tunnel syndrome type injuries may be avoided in that a mouse is not used. Thus, the user's wrist is not improperly bent or manipulated over a raised surface.

By way of background, the median nerve provides feeling and movement to the thumb side of the hand (the palm, thumb, index finger, middle finger, and thumb side of the ring finger) and the area in a wrist where the nerve enters the hand is called the carpal tunnel. This carpal tunnel is quite narrow, and swelling can pinch the nerve and cause pain, numbness, tingling, weakness and many other discomforts including the inability to close the hand. This is deemed carpal tunnel syndrome and is common in people who perform repetitive motions of the hand and wrist. Using a mouse input device is probably the one common cause of carpal tunnel syndrome. Many attempts have been made to avoid carpal tunnel injuries, however, the amount of injuries are prevalent.

The input device 100 is advantageous and has a configuration where the user's wrist is not strained when inputs are provided to control a cursor on a graphical user interface and the carpal tunnel is not put in any position where pressure or swelling may occur. Further, as discussed herein, the user is not constrained and includes finger tips that are free for typing on a touch screen or keyboard and the user only wears a breathable light weight assembly over a portion of the body as discussed herein.

The inputs may be provided at the same time a user types using a keyboard 410 shown in FIG. 4. The input device 100 preferably outputs wireless signals to a computer device 400 shown in FIG. 4. The computer device 400 receives the wireless signals and uses the wireless signals to provide inputs to an operating system graphical user interface. For example, the inputs may be used to move a cursor on a display 405, to select text, to enter data, to highlight data, to provide multi-touch functionality or to provide any and all input functionality known in the art. In another embodiment, instead of using a laptop computer 400 as shown, the input device 100 may be used with a tablet computer or mobile phone using a touch screen.

FIG. 1 illustrates a user's hand 125 including an index finger 120 and a thumb 115 and wearing the impedance tracking device touch pad 110. Preferably, an index finger 120 serves as a support for the input device 100 and the thumb 115 permits the user to input data using the input device 100 by running the thumb 115 along a flat surface of the touch pad 110 of the input device 100, which provides a signal that is provided to the computer device 400. FIG. 1 shows only one preferred placement of the input device 100 and it should be appreciated that the input device 100 may be supported on the thumb 115, other fingers or on the hand 125.

FIG. 1 shows that the input device 100 includes a band component 130 that completely or partially encircles the index finger 120 and a touch pad device 110 that is supported on the band component 130. The touch pad device 110 faces an opposite side of a lateral side of the index finger 120 to permit the touch pad device 110 to directly face the thumb 115 and to permit the thumb 115 easy access to a surface of the touch pad device 110. The input device 100 forms a wearable ring shaped component or band component 130 that has a substantial “O” shaped (or alternatively “D” shaped) cross section. The band component 130 can be made from a resilient thermoplastic member that encircles the index finger 120. In another embodiment, the component 130 can be a smooth fabric portion so the input device 100 can be worn for long periods of time and without chafing the user or interfering with the user's typing or daily activities.

Generally, the component 130 can be supported on a finger and may be located between a finger tip and a knuckle of the wearer on the index finger 120 of the hand 125. In another embodiment of the present disclosure, the component 130 may circle the entire finger all the way around or may encircle a portion of the finger and form a C shaped member. It should be appreciated that the term “ring” or “band” does not imply that the component 130 encircles completely the index finger 120. In another alternative embodiment, the component 130 may be a band shaped member 130 that may encircle or that may partially encircle the four fingers of the hand 125.

The component 130 is cylindrical in shape and includes an opened pair of ends 131 and 133 (FIG. 3) to allow the index finger 120 to pass through while a tip of the index finger 120 remains free. This provides an advantageous feature in that the user's index finger 120 tip can be used to touch a touch screen and provide inputs and also to provide tactile feedback to the user when the user is typing in a comfortable manner.

The component 130 comprises a touch pad device 110 that forms a general orthogonal or rectangular shaped portion for contacting the thumb 115. The touch pad device 110 may be located on an outward surface of the component 130 and generally extends from a lateral side of the index finger 120.

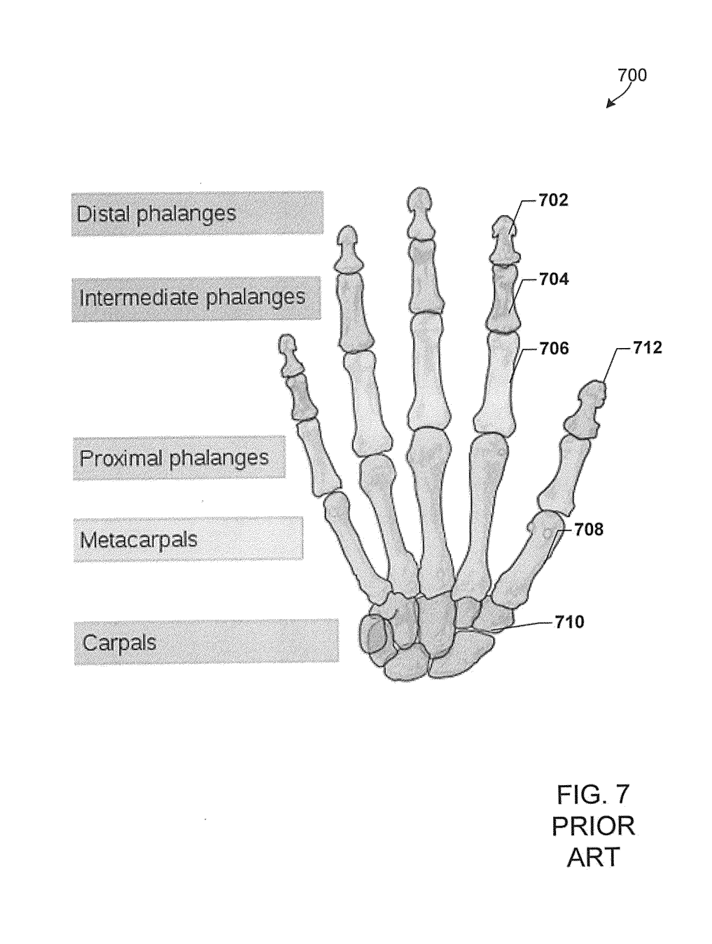

FIG. 7 shows a schematic of a number of bones in the hand 125 of FIG. 1 to illustrate a preferred placement of the component 130. As shown, the hand 700 includes distal phalanges 702 and intermediate phalanges 704 and proximal phalanges 706 connected to metacarpals 708 and which are connected to the carpals 710. The component 130 may be connected over the intermediate phalanges 704 and the proximal phalanges 706. In another embodiment, the component 130 may be placed over a different portion. In this manner, the thumb 712 of the user may access the touch pad device 110 in a relative easy manner and in a repeated basis without straining or applying any pressure to the carpal tunnel. The input device 100 preferably takes advantage of certain aspects of the thumb 712 that contrast with each of the other four fingers by being the only finger that is opposable to the other four fingers and has greater breadth of movement and opposability. Thus, the user may contact the touch pad device 110 using a user's thumb 712 while typing to provide an input command.

FIGS. 2-4 illustrate a left and right side view of the input device 100. FIG. 2 illustrates a number of interior components in a partially exploded view. The input device includes a control circuit that is located on a control board 200 with the input device touch pad device 110 being removed. The control circuit 200 connects the power supply 205 to the touch pad device 110 and also connects the wireless transmitter device 210 to the power supply 205 and touch pad device 110. The input device 100 also includes a power supply 205, which is rechargeable, or in another embodiment, is replaceable. In one embodiment, the power supply 205 is a lithium ion or nickel cadmium battery. The power supply 205 may be an electrical battery that includes a compact and lightweight electrochemical cell that converts stored chemical energy into electrical energy.

The input device 100 includes a wireless transmitter device 210. The transmitter 210 includes electronics and is preferably a short range RF radio transmitter 210 that includes an antenna that produces radio waves that are received by the computer device 400 or receiver component to communicate the inputs generated by the touch pad device 110 to the computer device 400. The transmitter 210 generates a radio frequency alternating current, which is applied to the antenna and when excited by the alternating current, the antenna radiates radio waves in a predetermined format that are transmitted to the receiver associated with the computer device 400. In one aspect, the input device transmitter 210 may be a Wi-Fi® transmitter or Bluetooth® transmitter device. In another embodiment, the transmitter 210 may be a transceiver that can also receive signals. In yet another embodiment, the input device 100 may include separate transmitter 210 and receiver devices. For example, the receiver of the input device 100 may receive a signal to pair the input device 100 and the computer device 400 so the computer device and input device 100 communicate in a secure or encrypted fashion.

FIG. 3 illustrates an opposite side view of the input device 100. The input device includes a hook and loop fastener portion 302 and a fabric mesh portion 304. The hook and loop fastener 302 has two components or fabric strips which are connected (e.g., sewn, adhered, stapled etc.) to the opposing surfaces of the band component 130. When the two faces are pressed together, the hooks catch in the loops and the two pieces fasten or bind temporarily.

In this aspect, the band component 130 may be sized to a number of sizes. This sizing may be for securing the band shaped component 130 around a number of differently sized index fingers in a secured manner so the user may type or perform daily tasks while keeping the band shaped component 130 snugly around the index finger 120 of the user with the touch pad device 110 oriented correctly. In an alternative embodiment, the band component 130 may include a different sizing device. For example, the band component 130 may include an interlocking portion that can size the band component 130 to different sizes.

The band component 130 may further include a meshing 304 that includes a number of apertures so the band component 130 is comfortable and allows heat to be exchanged through the band component 130. The mesh 304 may encompass the entire band shaped component 130 or only a portion thereof and may be formed from a loosely woven or knitted fabric that has a large number of closely-spaced holes, similar to sports jerseys and other clothing. The mesh 304 allows the band component 130 to remain lightweight and comfortable. For example, the band component 130 may comprise a first material and a second mesh portion 304 where the first material may comprise rayon, or alternatively a resilient material.

In another embodiment, the position may be inverted and the band component 130 may be placed on the thumb 115 and the index finger 120 of the hand 125 may provide the input signals on the touch pad device 110. For example, the band shaped component 130 may be provided between a thumb tip and a thumb knuckle on distal phalanges 702 or proximal phalanges 706 of the thumb 712 as shown in FIG. 7. The index finger 120 may contact the touch pad device 110 and provide the input signals. In a further embodiment, the user may wear a first input device 100 on the left hand index finger and may wear a second input device 100 on a right hand thumb to provide multiple input signals to the graphical user interface.

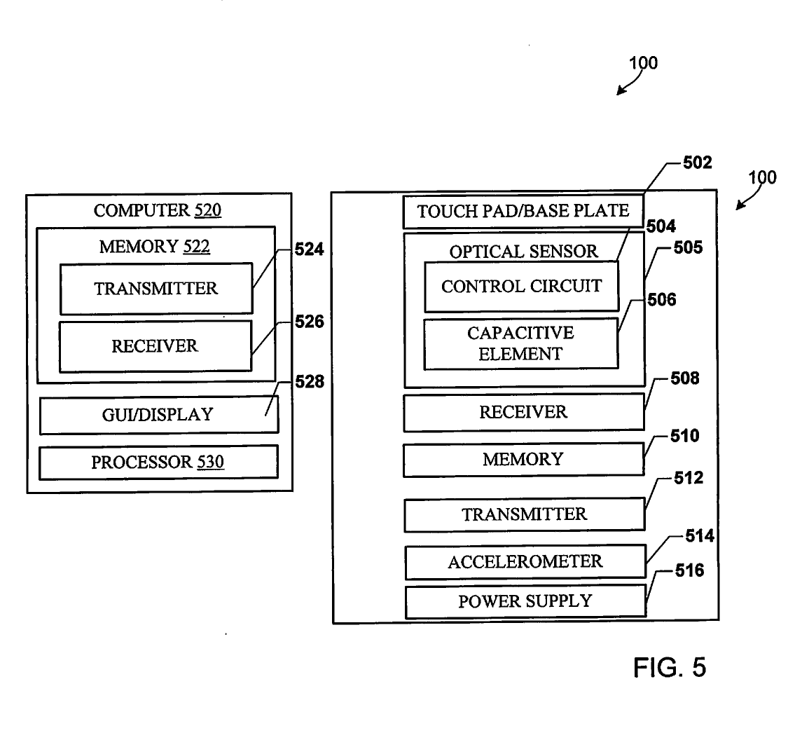

FIG. 4 illustrates the input device 100 wirelessly communicating the input command to a second computer device 400. In one embodiment, the wearable band shaped component 130 may include a transmitter 512 (FIG. 5) to transmit the input command. In another embodiment, the input device 100 may be connected by a wired connection to the computing device 400 or may include a transceiver.

In operation, the input device 100 may be placed so a touch pad device 110 is located on a lateral side of the band shaped component 130 to provide access to the thumb 115 where the thumb 115 may traverse laterally in a direction toward the index finger 120 to touch the touchpad device 110 and provide the inputs. Thus, the wearer can type on a keyboard 410 or on a touch screen having a finger tip free and may provide the input command using the component 130 and touch pad device 110 at the same time. In one embodiment, the computer 400 may include a USB dongle 415 that is connected via a USB port of the computer 400 and that receives a signal from the input device 100 and communicates the received signal to the computing device 400.

In an alternative embodiment, the input device 100 may include an opposite side relative to the touch pad device 110 that comprises a pressure sensitive area that may form one or more buttons that may provide additional inputs. In this aspect, the input device 100 may comprise a second touch pad device to detect an input signal opposite the touch pad device 110.

FIG. 5 illustrates a high level diagram of a computer device 520 communicating with the input device 100 using impedance tracking and illustrating components disposed therein. The input device 100 includes a touch pad base plate 502 that includes an optical sensor 505, a control circuit 504, a capacitive element 506, a receiver 508, a storage medium 510, a transmitter 512, a power supply 516 and an optional accelerometer 514 to provide signals to the control circuit 504.

The computer device 520 may comprise a laptop computer, a desktop computer, an electronic book reader, a tablet computer or a mobile communication device and may include various forms. The computer device 520 may include a memory 522, a processor 530 for providing control instructions, a display and graphical user interface 528 and a receiver 526 and transmitter 524.

The touch pad device 110 is a movement tracking device. The touch pad device 110 can be an optical tracking device and may include a base plate 502 and an optical sensor 505 contained within the base plate 502. The base plate 502 includes a top planar surface as shown in FIG. 1. The base plate 502 allows for a smooth consistent motion of a thumb on a tracking device and over a surface and ensures that a consistent distance and an even surface contact are maintained between an optical sensor 505 and the contact surface. This contact is provided so the optical signal of the touch pad 502 can receive an input from the thumb's motion 115 on the touch pad 502.

The optical sensor 505 is operatively connected to a control circuit 504 and a capacitive element 506 accurately tracks movement of a thumb 115 over a surface. The optical sensor 505 generates an electrical movement signal in response to a thumb's 115 movement over the surface. The electrical movement signal is provided to the transmitter 512. The transmitter 512 converts the electrical signal to a specific predetermined format and transmits the signal.

The movement signal generated by optical sensor 505 is transmitted to the transmitter 512 and the transmitter 512 communicates the movement signal to a receiver 526 associated with the computer 520. The receiver 526 communicates the signal to a computer processor 530 and the processor 530 outputs control instructions for controlling a cursor on a graphical user interface display 528. In another embodiment, the input device 100 may include a transceiver device for transmitting and receiving data from the computing device, or may include a receiver 508 and a transmitter 512 that are separate components. The optical sensor 505 also includes a control circuit 504 that may be a processor that is connected to a power supply 516. The input device 100 may also include a memory 510.

Memory 522 includes program instructions for a graphical user interface 528. The GUI 528 allows users to interact with electronic devices with images rather than text commands. GUIs 528 can be used in a computer, a hand-held device such as MP3 players, a portable media player or a gaming device and may have various forms. A GUI 528 represents the information and actions available to a user through graphical icons and visual indicators such as secondary notation, as opposed to text-based interfaces, typed command labels or text navigation. The actions are usually performed through direct manipulation of the graphical elements.

The computing device 520 may also transmit data from the computing device 520 to the input device 100, which is received by the input device 100 using a receiver 508. For example, the input device 100 may be paired using an initialization procedure with the computing device 520 and may receive signals from the computing device to ensure a secure encryption of data between the input device 100 and the computing device 520 over a predetermined channel. In one embodiment, the computing device 520 may include a dongle that is wirelessly connected to the transmitter 512 of the input device 100 as shown in FIG. 4. In another embodiment, the input device 100 may include a switch to power on the input device 100 and to provide the signal as thumb 115 contacts the touch pad 502 device. The input device 100 may be operable with a rechargeable battery 516 as a power supply to supply electrical power to the touch pad optical sensor 505.

FIG. 5 shows a computer device 520 that includes a receiver 526 to receive the input command. The receiver 526 is operatively connected to the computer device 520. The computer device 520 receives the input command using the receiver 526, and which can be communicated to a software operating system. The computer device 520 includes a processor 530, a memory 522, a display 528 and an input device 410 or keyboard 410 shown in FIG. 4. The processor 530 may include the software operating system that receives the input command and that generates a control signal in response to the input command.

The graphical user interface 528 may include a pointer icon that may select text, move on the display screen or that may select hyperlinks. The input command from the thumb 115 on the touch pad 502 is sensed by the capacitive element 506 and optical sensor 505 and transmitted by the transmitter 512. The signal is received by a receiver 526 and is communicated to the processor 530 as a control signal. The processor 530 may receive the signal and output a control signal to move an icon on a display 528 in the same manner as the movement of a thumb 115 on the input device 100. Various other GUI commands are also envisioned and within the scope of the present disclosure.

For example, the thumb 115 may push down or tap on the touch pad 502, which may be interpreted as a different second input signal interpreted to select an icon or image on GUI 528 using the touch pad 502. In yet another embodiment, the touch pad 502 may be suitable for multi-touch input commands using a thumb 115 and a finger from an opposite hand to provide multi-touch inputs. For example, a flick may be interpreted on the touch pad 502 as a different input signal or two fingers touching as a different input signal. Touch pad 502 may operate in one of several ways, including capacitive sensing and conductance sensing. The optical sensor 505 can sense the capacitive virtual ground effect of a thumb 115, or the capacitance on the optical sensor 505. In another embodiment, the touch pad 502 may include two or more optical sensors 505.

In another embodiment, the input device 100 includes a transmitter 512 that communicates data in a predetermined wireless RF format. For example, the input device 100 may communicate data using an IEEE 802.11 set of standards for implementing wireless local area network (WLAN) computer communication in the 2.4, 3.6 and 5 GHz frequency bands. In another embodiment, the input device 100 may communicate to the receiver 526 via a short range wireless format. For example, the computer 520 may include a Bluetooth® wireless PC card that is used to exchange radiofrequency signals.

For example, the input device 100 may include a Bluetooth® compatible transmitter 512 that transmits input data via low-power radio waves and may transmit an RF signal to the computer device 520 on a frequency of 2.45 GHz. The input device transmitter 512 may use a spread-spectrum frequency hopping to avoid interference. When the input device 100 is paired with the computer 520 the devices 110 and 520 form a personal-area network (PAN), or piconet. Once a piconet is established, the computer 520 and the input device 100 randomly hop frequencies in unison so as to ensure communication and to avoid other piconets that may be operating close by. Therefore, the input device 100 includes a circuit 504 to receive an output from the optical sensor 505 to translate the output into data suitable for the piconet. The data is communicated to the transmitter 512. The computer device 520 may include a wireless dongle that receives the signal from an integral receiver 526 and that communicates the signal to a computing device 520 via a port formed on the computing device 520.

In another alternative embodiment, the input device 100 may further include an accelerometer 514 to provide a second sensor input. The accelerometer 514 may detect acceleration and may be operatively connected to the control circuit 504. The accelerometer 514 may also provide input signals to the graphical user interface. For example, the accelerometer 514 may provide at least one signal as to the thumb's 115 or hand's movement is made in the forward, back and left and right directions, which can be transmitted by the transmitter 512 to the receiver 526. The graphical user interface may receive the inputs and control the input icon in a similar manner. In another embodiment, the accelerometer 514 may replace the optical sensor 505, or may supplement the inputs from the optical sensor 505. For example, the accelerometer 514 may receive a spike of acceleration indicating that the input device 10 has fallen to the ground and the inputs received on the optical sensor 505 should be disregarded. In another embodiment, a sharp spike of acceleration a time period later may indicate that the user has regained possession of the input device 100 and that the optical sensor 505 inputs should be received and transmit to the receiver 526. In another embodiment, the input device 100 may include at least two accelerometers 514 for user interface control. In another embodiment, the accelerometer 514 may be used to detect whether the input device 100 is being held correctly to transmit the input signals to the receiver 526. In one aspect, the accelerometer 514 may be a three-axis accelerometer for motion input. In an alternative embodiment, the accelerometer 514 may have more than three-axis and may comprise a six-axis accelerometer 514.

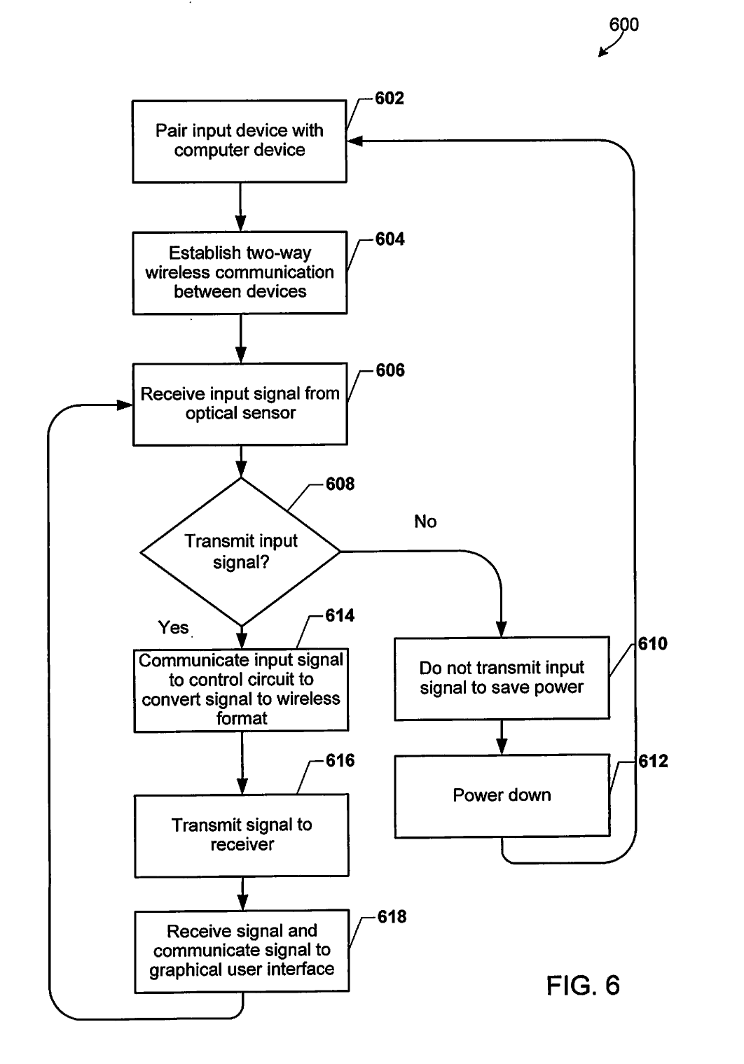

FIG. 6 illustrates an embodiment method 600 for recognizing input commands using an input device 100 that is worn on the index finger 120 or that is worn on a user's thumb 115. Method 600 may be implemented in a computing device having a processor configured with processor-executable instructions to perform the operations of the method 600.

In method 600, the processor may commence operation by pairing the input device 110 with the computing device 520 for secure wireless communication between the input device 110 and the computer device 520 at block 602. In embodiment method 600, the processor may establish a two way wireless communication between the input device 100 and the computer device 520 in block 604. In another embodiment, one way communication from the input device 110 to the computer device 520 also may be possible. In this manner, input signals are communicated from the input device 100 to the receiver 526 of the computer device 520 to provide input signals for a graphical user interface 528. In block 606, the embodiment method 600 may receive an input signal from the optical sensor 505. For example, a user may drag a thumb over the flat surface and the optical sensor 505 may detect the movement. For example, the touch pad device 110 may alternatively be mounted to the thumb 115, and the user may use the index finger 120 to provide the input signal on the touch pad device 110.

In decision block 608, the processor may compare data to determine whether to transmit the input signal. If so, (i.e., decision block 608=“Yes”), which indicates to transmit the input signal, the processor will control to communicate the input signal to a control signal to convert the signal to a wireless format in block 614. In block 616, the processor will control the transmitter to transmit the signal to a receiver. In block 618, the processor of the computer device will receive the signal and communicate the signal to the graphical user interface in block 618. On the other hand, if the processor determines not to transmit the input signal for example for power savings, (i.e., decision block 608=“No”), which indicates to save power, the processor may not transmit the input signal to save power in block 610. In block 612, the processor may control the input device to conserve the battery power and power down.

The present disclosure provides a flexible cursor and interface control pad 110 worn on the index finger 120 of either hand, operated by the adjacent thumb 115 manipulating the control surface 110. The device 100 may communicate using the Bluetooth® wireless communication protocol with a host machine, which could be a notebook personal computer, a tablet, a mobile phone, a television, a set top box, interactive television, or any other portable device which can communicate wirelessly. In this aspect, the input device 100 may be used as a remote control device for a television set, a cable box, or can be used for a remote key fob device for an automobile.

The device 100 can be fully used while typing, as well as, when sitting, or when standing in a comfortable position, thus significantly reducing the risk of repetitive strain injury (RSI), as well as providing positional flexibility during presentations, and when walking, or running. For example, the input device 100 may transmit signals to an APPLE® Computer I-POD® media player. The input device 100 allows for placement on fingers of all sizes. Power to the device 100 is provided by a replaceable small watch type or button battery 516 that has a small single cell battery shaped as a squat cylinder typically 5 to 12 mm in diameter and 1 to 6 mm high. The wireless communication protocol used is Bluetooth®, with the capability to add other different protocols as needed. Typical host computer devices 520 will support the Bluetooth protocol inherently, but the input device 100 may be supplied with a wireless remote receiver 508 (FIG. 5) for use on any device equipped with a USB slave port.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-Ray™ disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. An input device comprising:
a component that is supported on a finger and is located between a finger tip and a knuckle at a base of the finger of the wearer, wherein the component comprises a touch pad device that is located on an outward surface of the component, the touch pad device being contacted to provide an input command; and
a transmitter to transmit the input command.

2. The input device of claim 1, wherein the wearer types on a keyboard and provides the input command using the component at the same time, and wherein the touch pad device comprises a movement tracking device, and wherein the component is generally cylindrical in shape and open at a first end and open at a second opposite end.

3. The input device of claim 1, wherein the touch pad device comprises an optical tracking device.

4. The input device of claim 1, wherein the touch pad device has a base plate and an optical sensor.

5. The input device of claim 4, wherein the touch pad device provides for impedance tracking for reading movement, and wherein the base plate allows for a smooth consistent motion of a thumb on a tracking device and over a surface and ensures that a consistent distance and an even surface contact is maintained.

6. The input device of claim 1, wherein the touch pad device comprises an optical sensor that accurately tracks movement of a thumb over a surface and generates an electrical movement signal in response to the thumb's movement over the surface, and wherein the electrical movement signal is provided to the transmitter.

7. The input device of claim 6, wherein the transmitter communicates the movement signal to a receiver, wherein the receiver communicates the signal to a processor for controlling a graphical user interface on a display.

8. The input device of claim 1, wherein the component comprises a ring shaped member that comprises a meshing.

9. The input device of claim 1, wherein the component comprises a band member that is disposed to surround four fingers on a hand.

10. The input device of claim 1, further comprising a switch to power on the input device and to provide the signal as a thumb contacts the device.

11. The input device of claim 1, further comprising a dongle comprising a receiver wirelessly connected to the transmitter.

12. The input device of claim 1, further comprising a power supply.

13. The input device of claim 1, wherein the component is a deformable wearable index finger band.

14. The input device of claim 1, wherein the component is disposed on an index finger between a tip of the finger and a second index finger knuckle.

15. The input device of claim 1, wherein the component encircles an index finger and includes a first portion that detachably connects to a second portion by a hook and loop fastener.

16. The input device of claim 1, wherein the component encircles a body part and includes a first portion that detachably connects to a second portion by a hook and loop fastener, and wherein the hook and loop fastener is connectable at a plurality of different locations so the component is sizeable to a particular index finger of a user.

17. The input device of claim 1, further comprising:
a receiver to receive the input command; and
a computer device that receives the input command from the receiver; and
a software operating system comprising a graphical user interface that receives the input command and that generates a control signal in response to the input command.

18. The input device of claim 17, wherein the control signal moves an icon on a display in the same manner as the movement of a thumb on the touch pad.

19. The input device of claim 1, wherein the transmitter communicates data in a predetermined wireless RF format.

20. The input device of claim 19, wherein the predetermined wireless format is a Bluetooth format.

21. The input device of claim 1, further comprising a transceiver that transmits and receives signals.

22. The input device of claim 1, further comprising a rechargeable battery to provide power to the input device.

23. The input device of claim 1, further comprising a circuit to receive an output from the touch pad and to translate the output into data, wherein the data is communicated to the transmitter.

24. The input device of claim 1, further comprising an accelerometer that accurately tracks movement of a hand and generates an electrical movement signal in response to the hand's movement in space, and wherein the electrical movement signal of the accelerometer is provided to the transmitter.

25. A method comprising:
providing a first member on a body part, wherein the first member has an inner surface touching the body part and an opposite outer surface;
providing a touch pad on the outer surface;
inputting data using a thumb to touch the touch pad; and
wirelessly transmitting the data to a destination.

26. The method of claim 25, further comprising wearing the first member while typing.

27. The method of claim 25, further comprising wearing the first member on a left or right hand index finger.

28. The method of claim 25, further comprising opening the first member using a hook and loop fastener.

29. The method of claim 25, further comprising closing the first member using a hook and loop fastener.

30. The method of claim 25, further comprising transmitting the data using a transmitter.

31. The method of claim 25, further comprising transmitting the data via a predetermined protocol.

32. The method of claim 25, further comprising inputting data using the thumb to touch the touch pad and detecting movement by capacitive sensing.

33. The method of claim 25, further comprising inputting data using the thumb to touch the touch pad and detecting movement by conductance sensing.

34. The method of claim 25, further comprising typing on a keyboard;
inputting data using the thumb to touch the touch pad and wirelessly transmitting the data to the destination at the same time, and
receiving output of an accelerometer and providing the output to control a graphical user interface.

35. The method of claim 25, further comprising detecting pressure on a side opposite the touch pad to provide a second input.

36. A computer comprising:
a processor;
a memory;
a receiver;
a display;
an input device supported on a finger that comprises a touch pad device that is located on an outward surface, the touch pad device being contacted to provide an input command, wherein the input device is supported on the finger by a member opened at two ends so a finger tip is free; and
a transmitter to transmit the input command to the receiver and to provide inputs to the processor.
